(19) United States
(12) Patent Application Publication
(10) Pub. No.: US 2012/0195157 A1
(43) Pub. Date: Aug. 2, 2012

(54) BONE CEMENT MIXING APPARATUS, AND RELATED METHOD

(76) Inventor: Colin McKay, Uddingston/ Glasgow (GB)

(21) Appl. No.: 13/394,784

(22) PCT Filed: Sep. 6, 2010
(86) PCT No.: PCT/GB2010/051475

§ 371 Date: Apr. 9, 2012

(30) Foreign Application Priority Data
Sep. 7, 2009 (GB) 0915566.4

(51) Int. Cl. B01F 13/00; B01F 15/02

(52) U.S. Cl. 366/130

(57) ABSTRACT

Disclosed is a bone mixing apparatus (100) comprising a mixing cylinder (110) with ends (111) and (112). End (111) is a closed whereas end (112) is open and capable of being attached to other apparatus. The mixing cylinder (110) forms a cavity within which the mixing of different components used to form bone cement may occur. The mixing cylinder (110) may therefore form a closed sealed container with which hazardous gases formed during the mixing process may be contained. This prevents the hazardous gases from coming into contact with persons in the surrounding area. Attached onto a central region of the mixing cylinder (110) there is a compartment (114) which is used to receive a cartridge (118). The compartment (114) basically functions as replaceable part which forms part of the sealed enclosure. The cartridge (118) comprises different components which go to make up the bone cement. The cartridge (118) may therefore comprise a powder material and a liquid material which are initially separated in different parts of the cartridge (118) but when mixed form the bone cement mixture. Further disclosed is also a method for dispensing bone cement mixing material.

### FIELD OF THE INVENTION

The present invention relates to nixing apparatus and a method of mixing different components. in particular, the present invention relates to bone cement mixing apparatus along with a method for mixing material to fill bone cavities.

### BACKGROUND OF THE INVENTION

In orthopaedic surgery acrylic bone cement is used as a grout to fixate implants that restore joint function, The cement is composed of a powder polymer contained in a paper packet and liquid monomer contained in a glass ampoule, When combined together in a mixing cylinder and mixed together the two components polymerise and can be injected from the mixing cylinder via means of a cement gun into or onto the appropriate anatomy. As the vapour from liquid monomer is a hazardous chemical, it is important to minimise hospital staffs (e.g. theatre staff's) exposure to these vapours. With current mixing systems in the art, a powder sachet is cut open with scissors to pour into a mixing cylinder and a liquid monomer in a glass ampoule is broken open and poured into the mixing cylinder. This means that the hospital staff are exposed to the vapour from the monomer. To minimise exposure, a vacuum lined with a charcoal filter my be added to the mixing cylinder and connected to a vacuum pump which Will help remove the vapours from the mixing cylinder. However, there is an existing need in the art to obtain a bone cement mixing system which is capable of mixing the different components used to form the mixing material and which reduces the contact of hazardous gaseous gases with hospital staff.

WO 2008/045329 relates to a bone cement mixing system with an automated mixing compartment. However, this patent relates to a mixing compartment which is separate from the cement gun, The mixing cylinder is then required to be placed on a cement gun that does not have the capability of mixing the cement, does not contain an easy-to-use trigger actuation system, and the sole function of the cement gun is to expel the cement from the mixing cylinder.

CA 2593506 relates to a method for ejecting components of cement stored in separate units into a mixing cylinder by an aerosol gas (which is activated by a snap at a joint between the mixing cylinder and the container of the components),

It is an object of at least one aspect of the present invention to obviate or mitigate at least one or more of the aforementioned problems.

It is a further object of at least one aspect of the present invention to provide bone cement apparatus capable of mixing material to fill bone cavities and which eliminates or at least minimises the contact between hospital staff and dangerous gases formed during the mixing process.

It is a further object of at least one aspect of the present invention to provide a method of eliminating or at least minimising the contact between hospital staff and dangerous gases bone when mixing material to fill bone cavities.

It is a yet further object of at least one aspect of the present invention to provide an improved bone cement apparatus capable of providing improved mixing efficiencies.

It is a yet further object of at least one aspect of the present invention to provide an improved method of mixing bone cement mixing material which provides improved mixing efficiencies.

### SUMMARY OF THE INVENTION

According to a first aspect of the present invention there is provided a bone cement mixing apparatus, said bone cement mixing apparatus comprising:

a mixing chamber;

an opening located on the mixing chamber, the opening being closeable and;

wherein the opening on the mixing chamber is capable of receiving the components for forming a bone cement mixture.

The mixing apparatus according to the present invention therefore relates to a system for mixing different components such as a powder and a liquid component which may be used to form a bone cement mixture, There may be any number of different components such as two, two or more or plurality which, are initially separated and intended to be mixed together.

The mixing apparatus has the advantage in that hazardous gases which may be formed during the mixing of the different components are contained and sealed within the mixing apparatus and therefore do not come into contact with a user such as hospital staff including that of a surgeon. The mixing apparatus may therefore be capable of forming a closed system for mixing the different components.

The mixing chamber may be a mixing cylinder. The mixing chamber may he of a tubular-like form with a hollow inner cavity which may be used as an environment to mix the different components. Typically, the mixing chamber may be made from material which is un-reactive to the components which are used to mix to form the bone cement mixture.

Typically, the mixing chamber comprises an opening which may be in the form of a hatch or a trap door which may be used to receive the components for forming the bone cement mixture. The opening may be closeable using any suitable means such as a sprung activated mechanism.

The mixing apparatus may also comprise a compartment which may be fitted onto the mixing chamber and which may be used to receive a cartridge. The cartridge may contain the different components which are intended to be mixed to form the bone cement mixture. Typically, the compartment may be in the form of any suitable receptacle which may comprise an orifice through which the cartridge may be inserted.

Once the cartridge is placed in the mixing chamber and over the opening located on the mixing chamber, the compartment may then be removed and the contents of the cartridge dispensed into the mixing chamber. To facilitate the dispensing of the different components into the mixing chamber, a vacuum or reduced air pressure may be formed in the mixing chamber.

The cartridge may contain any number of different components which may be contained in separate compartments within the cartridge. On placing the cartridge onto the mixing chamber, the different compartments may be mixed with each other using any suitable means and, for example, the compartments may be broken under reduced pressure. Alternatively, the compartments may be frangible and easily broken by rotating an inner member breaking the required surfaces.

The bone cement mixing apparatus may also comprise a nozzle arrangement through which the contents in the mixing chamber may be dispensed.

In particular embodiments, the mixing apparatus may be connected to a dispensing gun which may provide automated dispensing of the material in the mixing chamber. The dispensing gun may be of any suitable automated means and may comprise an on/of button, a reset button and/or a timer button. The dispensing gun may comprise a pushrod or lead-screw which may be automatically activated thereby progressively pushing the contents out of the mixing chamber and through the nozzle into the bone cavity such as a femoral cavity to be repaired.

To facilitate the mixing of the contents in the mixing cylinder, the mixing apparatus may comprise mixing means which may, for example, be rotated during the dispensing of the material such as a paddle or any other suitable type of stirrer.

In further embodiments the bone mixing apparatus the mixing chamber may be in the form of a mixing cylinder. The mixing cylinder may comprise a centrally located shaft The mixing chamber may comprise a compartment capable of receiving a frangible cartridge such as a glass ampoule. The mixing cylinder may also comprise a mixing paddle and a plunger. In use, powder used to form the bone cement such as, for example, from a sachet may be emptied into the mixing chamber. An end cap may then be placed on the mixing cylinder. As the end cap is placed against the end of the mixing chamber and the end cap pushed down, the frangible cartridge containing liquid material to form the bone cement may burst/break and the contents of the frangible cartridge then make contact with the powder material in the mixing chamber. The contents of the frangible cartridge may enter the mixing chamber through a small side-opening in the mixing chamber There may be a small mesh to prevent any glass fragments from falling into the mixing chamber, The mixing chamber may then be connected to a dispensing gun. The dispensing gun may comprise a central cavity and a motor capable of dispensing the bone cement from the mixing chamber. In a first movement, the shaft along with a plunger connected to the dispensing gun may translate along the length of the central cavity causing the shaft to rotate and the contents of the mixing chamber to be mixed, In a second movement, the shaft may move in the opposite direction along the length of the central cavity causing the shaft to rotate and cause further mixing. A clip (e.g. locks) connecting the mixing cylinder to the central cavity may then be disconnected and the mixing cylinder is then capable of moving freely from the plunger. The contents of the mixing cylinder may then be expelled from the mixing chamber and, for example, expelled through a nozzle.

In a further bone mixing apparatus the bone mixing apparatus may comprise a mixing cylinder, a shaft and a mixing paddle. The mixing cylinder may comprise an outlet. The mixing cylinder may be used with a dispensing gun comprising a rack and a motor pinion wheel. According to a second aspect of the present invention there is provided a method for dispensing bone cement mixing material, said method comprising;

providing a mixing chamber;

providing an opening located on the mixing chamber, the opening being closeable; and

wherein the opening on the mixing chamber is capable of receiving the components for forming bone cement mixture.

Typically, the bone cement mixing apparatus may be as defined in the first aspects.

According to a third aspect of the present invention there is provided a use of the bone cement mixing apparatus as defined in the first aspect in mixing components to form a bone cement mixture.

According to a fourth aspect of the present invention there is provided a mixing chamber and a cartridge.

The mixing chamber and cartridge may be as defined in the first aspect.

According to a fifth aspect of the present invention there is provided a bone cement mixing apparatus, said bone cement mixing apparatus comprising:

a mixing chamber;

wherein the mixing chamber is capable of receiving e components for forming a bone cement mixture.

In these types of embodiments the mixing chamber therefore forms a closed system that already contains the bone cement mixing material,

The other parts of the bone cement mixing apparatus may be as defined in any of the previous aspects but with a closed mixing chamber.

### BRIEF DESCRIPTION OF THE DRAWINGS

Embodiments of the present invention viii now be described, by way of example only, with reference to the accompanying drawings in which:

FIGS. 1a-1c are representations of part of bone mixing apparatus according to an embodiment of the present invention in different states of use;

FIG. 2 is a representation of the bone mixing apparatus shown in FIGS. 1a-1c and also showing a mixing paddle;

FIG. 3 is a further representation of the mixing paddle shown in FIG. 2;

FIG. 4 is a top view of the mixing paddle shown in FIGS. 2 and 3;

FIGS. 5a-5c are representations of one mixing apparatus attached to a dispensing gun according to an embodiment of the present invention;

FIG. 6 is a representation of a dispensing gun according to a further embodiment of the present invention;

FIG. 7 is a representation of a mixing cylinder attached to a dispensing gun according to a further embodiment of the present invention;

FIGS. 8a-8c are representations of a bone mixing apparatus according to a further embodiment of the present invention;

FIGS. 9 and 10 are representations of the bone mixing apparatus shown in FIGS. 8a-8c with a cement dispensing gun;

FIGS. 11a-11h are representations of the bone mixing apparatus shown in FIGS. 8a-8c and FIGS. 9 and 19 in use;

FIGS. 12 and 13 are representations of a bone mixing apparatus according to a yet further embodiment of the present invention; and

FIGS. 14a-14c are representations of the bone mixing apparatus shown in FIGS. 12 and 13 in use.

### BRIEF DESCRIPTION

The present invention relates to an automated bone cement mixing system which eliminates or at least reduces contact between hospital staff and dangerous gases during the mixing of bone cement. The bone cement mixing system achieves this by providing a closed system within which different components used to form the bone cement mixing material may be mixed. The present invention also provides an improved and easier method for mixing the different components used to form the bone cement mixing material.

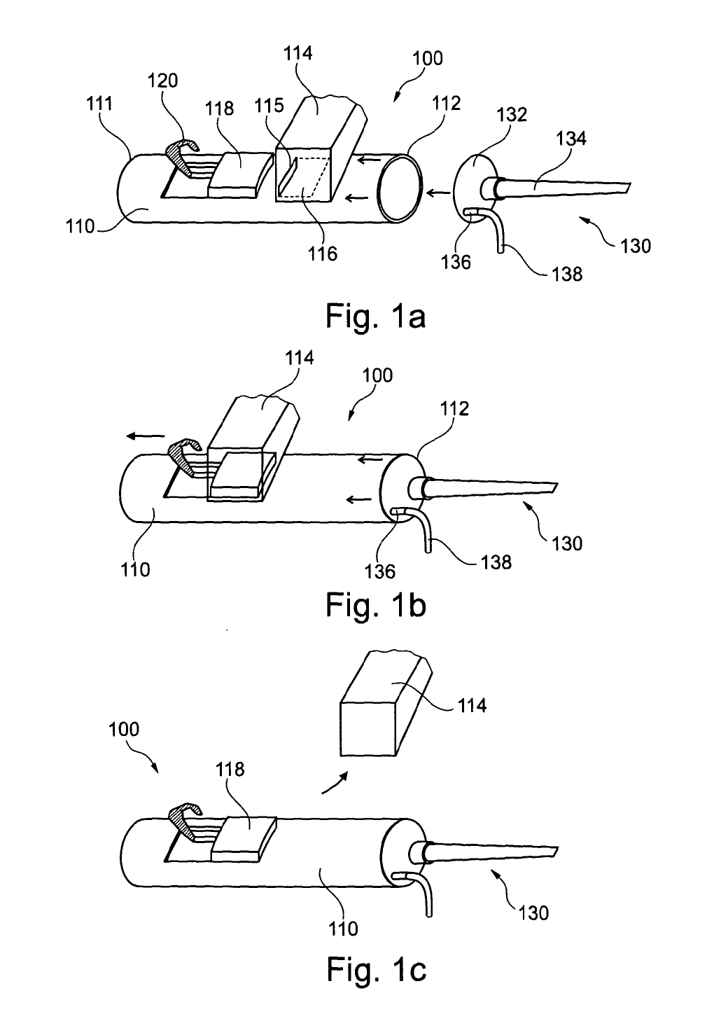

FIGS. 1a-1c are representations of part of the bone mixing apparatus according to the present invention generally designated 100. As shown in FIG. 1a the bone mixing apparatus 100 comprises a mixing cylinder 110 with ends 111 and 112. End 111 is a closed whereas end 112 is open and capable of being attached to other apparatus. The mixing cylinder 110 forms a cavity within which the mixing of different components used to form bone cement may occur. The mixing cylinder 110 may therefore form a dosed sealed container with which hazardous gases formed during the mixing process may be contained. This prevents the hazardous gases from coming into contact with persons in the surrounding area.

Attached onto a central region of the mixing cylinder 110 there is a compartment 114 which is used to receive a cartridge 118. The compartment 114 basically functions as replaceable part which forms part of the sealed enclosure, The cartridge 118 comprises different components which go to make up the bone cement. The cartridge 118 may therefore comprise a powder material and a liquid material which are initially separated in different parts of the cartridge 118 but when mixed form the bone cement mixture.

FIG. 1a also shows the cartridge 118 ready to be inserted into the compartment 114 via a slot 115 in the compartment 114, The cartridge 118 comprises a handle 120 to facilitate the pushing of the cartridge 118 into the compartment 114. FIG. 1a also shows that there is a nozzle 130 which comprises an annular member 132 for attaching to the end 112 of the mixing cylinder 110. The nozzle 130 also comprises a dispensing tubular member 134.

FIG. 1b shows the cartridge 118 inserted into the compartment 114 and is therefore loaded and fixed onto the mixing cylinder 110, The cartridge 118 is pushed into the compartment 114 using the handle 120 through the slot 116 on the compartment 114. The mixing cylinder 110 comprises an aperture 116 which is located below the position of the cartridge 118 when inserted and fixed onto the compartment 114. The slot 115 comprises a means for sealing the compartment 114 such as a sprung/trap/hatch door. The slot 115 may be provided to mechanically break a glass vial with a membrane or similar to prevent glass shards entering the mixing chamber or to pierce a foil container and mechanically push out, cut the foil with a blade, or peel off the foil.

As shown in FIG. 1b, the nozzle 130 is twisted onto the end 112 of the mixing cylinder 110. As the cartridge 118 is placed and fixed onto the compartment 114, the contents of the cartridge 118 are released into the inside of the mixing cylinder 110 through the aperture 116 which may be in the form of sprung/trap/hatch door. FIG. 1b shows that there is an opening 136 in the nozzle 130 with a tube 138 attached which may be used to suck air from the inside of the mixing cylinder 110 which therefore has the effect of sucking the contents of the cartridge 118 into the mixing cylinder 110. The different contents in the cartridge 118 may be separated by a frangible separation unit which may be burst and/or broken due to the partial vacuum created within the mixing cylinder 110. Under reduced pressure the different components of the cartridge 118 may therefore be fed into the mixing cylinder 110 ready to be mixed.

FIG. 1c shows the cartridge 118 attached to the mixing cylinder 110 with the compartment 114 removed. By adding the different components to the mixing cylinder 110 using the sealed environment of the cartridge 118 and the compartment 114 eliminates the possibility of hazardous gases formed during the mixing process from coming into contact with persons close by. This is a significant advantage over the prior art where the hazardous vapours are not contained and hospital staff are therefore exposed to the vapours and potential harm caused. Current systems use a funnel to add powder and the liquid component which are used to form the bone cement mixture with the result that the monomer vapour may contact hospital staff.

The cartridge 118 is therefore loaded with sterile cement components such as a powder and a liquid which are placed in separate compartments in the cartridge 118. On placement of the cartridge 118 onto the mixing cylinder 110 the contents of the powder compartment and the liquid compartment are released through the aperture 116 and are allowed to mix in the mixing cylinder 110. The mixing cylinder 110 is therefore capable of opening directly to the cartridge 118 without exposing the components and hence vapours formed during the mixture to a human user. The mixing cylinder 110 also forms a sealed unit for effective mixing of the bone cement mixtures.

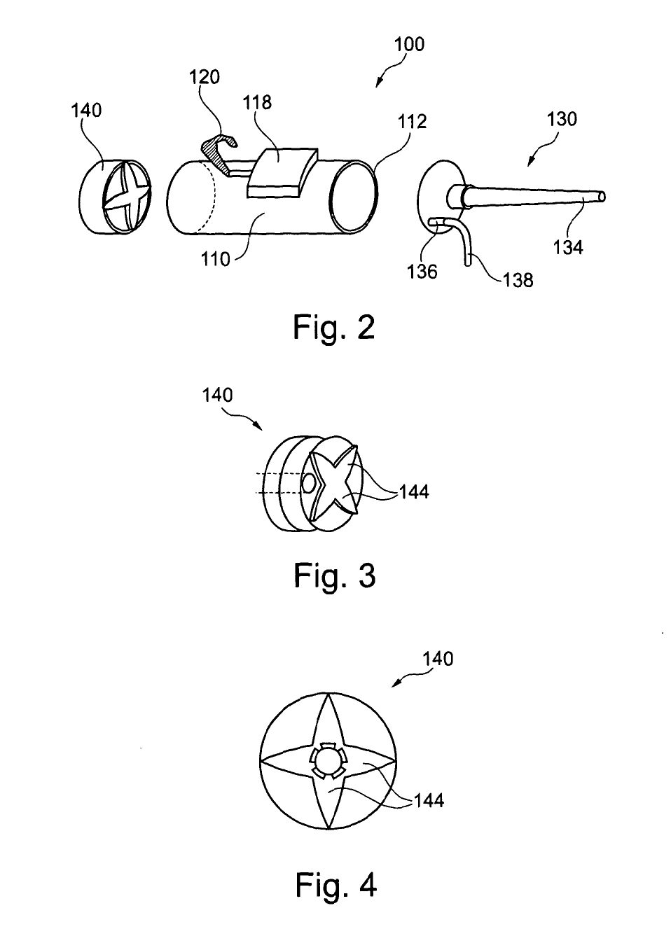

FIG. 2 is a representation showing the mixing apparatus 100 which comprises the mixing cylinder 110 with the cartridge 118 attached. The nozzle 130 is also attached ready to be attached to the end 112 of the mixing cylinder 110. FIG. 2 also shows a mixing paddle 140 which is used to mix the powder and liquid components once inserted into the mixing cylinder 110.

FIG. 3 is a further representation of the mixing paddle 140 and shows a star-like configuration 144 which is used to create turbulence and mix the powder and liquid components into a consistent mixture once inside the mixing cylinder 110.

FIG. 4 is an end view of the paddle 140 again showing the star like 144 mixture member.

When the different components have been placed in the nixing cylinder 110, the different cement components (i.e. the powder and liquid component) a vacuum is created using the pipe 138 to evacuate the air from the inner area of the mixing cylinder 110. This feeds the cement components from the cartridge 118 into the mixing cylinder 110. The mixing paddle 140 is used to obtain a consistent mixture. The pipe 138 used to obtain a vacuum may also contain a charcoal filter.

In contrast to prior art devices, the paddle 140 is automatically operated which is of great technical advantage. As the different components start to mix properly and the cement begins to thicken, it becomes quite difficult to mix and a reasonable force would have to be applied to manually mix the mixture which as the cement begins to thicken it becomes quick difficult to mix and a reasonable force has to be applied from the shoulder of the person mixing the mixture to mix the cement. In addition, the polymerisation reaction of the cement is influenced by temperature, humidity and the energy that the user applies to the mixing paddle 140. In prior art techniques there can therefore be variability in the outcome of the cement from one user to the next which is overcome in the present invention. Therefore, an automated hone cement mixing apparatus as described in the present application allows a much improved mix to be obtained and overcomes the difficulty of a user having to manually mix the components which as the polymerisation reaction proceeds becomes more difficult.

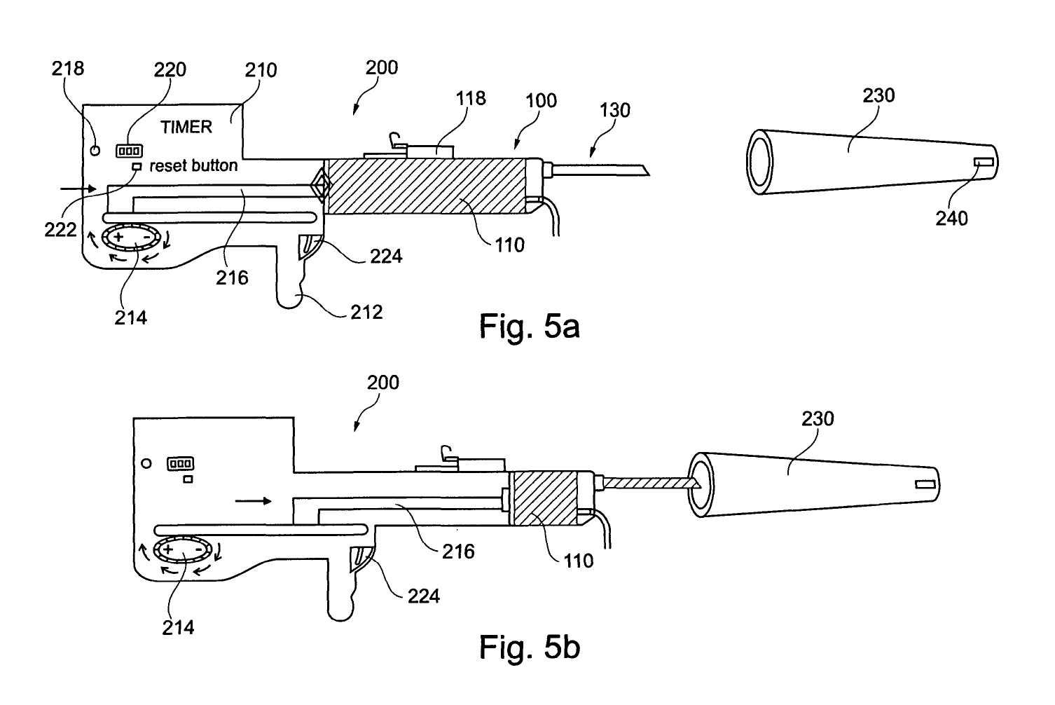

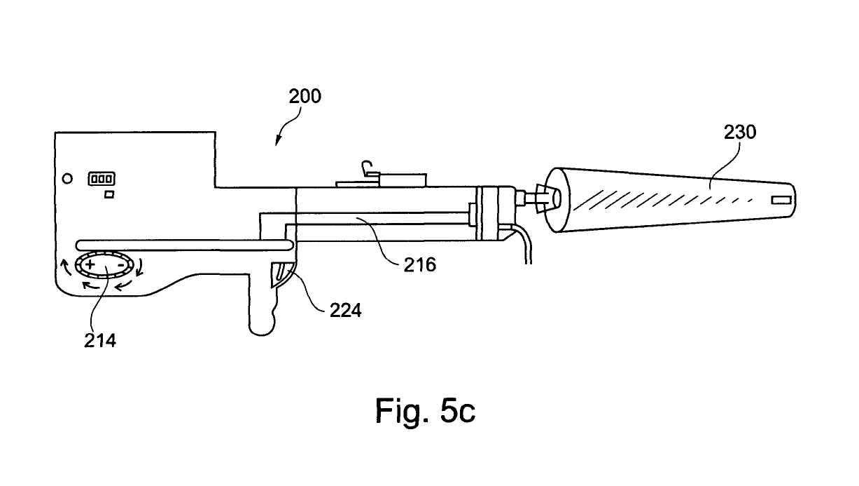

FIGS. 5a-5c show the complete automated bone cement mixing system 200 which comprises the mixing apparatus 100 and a cement dispensing gun 210. The cement gun may be of any suitable form but as shown in FIG. 5a the cement dispensing gun 210 comprises a handle 212 and drive means 214 for driving a pushrod 216 which activates the mixing cylinder 110. The dispensing gun 210 also comprises an on/off button 220, a timer 220 and a reset button 222. In FIG. 5a, the mixing cylinder 110 is filled with bone cement mixture and is brought adjacent to a femoral canal 230 which is to be filled and repaired. A cement restrictor 240 may be placed at the bottom of the femoral canal 230 to prevent excess unwanted bone cement mixture being inserted.

In FIG. 5b, about half of the contents of the mixing cylinder 110 have been dispensed by activating the pushrod 216 using the drive means 214 in the dispensing gun 210. A trigger 224 on the dispensing gun 210 is used to activate the pushrod 216 which dispenses the contents of the mixing cylinder 110,

In FIG. 5c, the whole contents of the mixing cartridge 110 have been dispensed and the damage to the femoral canal 230 has been repaired.

The dispensing gun 210 may therefore be activated using the on/off button 218 with the mix being stopped by pressing the on/off button 210 once the femoral canal 230 has been repaired and/or after a pre-set of time to stop the mix, This therefore eliminates or at least minimises any problems to the shoulder of a user associated over many years of mixing cement in orthopaedic theatres.

The dispensing gun 210 also has the function of not only dispensing the contents of the mixing cylinder 110 but also mixing the contents using the mixing paddle 140 using a rotating motion as the contents of the mixing cylinder 100 are discharged, Prior art systems use a ratchet or lever mechanism that requires a surgeon to squeeze the cement out of a gun. This requires a considerable degree of dexterity and some of the dispensing guns are difficult to get the cement out of the system for surgeons that have smaller hands. The device according to the present invention will eliminate this problem by having the dispensing gun 210 with a trigger actuation system. The trigger 224 when pulled back will activate a pushrod 216 that will automatically push the cement at the proximal end of the mixing apparatus 100 and begin to eject the cement from the mixing cylinder 110 via a nozzle 130 into or on the appropriate anatomy with no necessary dexterity from a user such a surgeon. The pushrod 216 may be driven by any suitable motorised means such as motor driving a pulley system. Again the force required can be pre-determined to allow the most appropriate release of the cement from the mixing cylinder 110 to the point of application. The trigger 224 on the dispensing gun 210 can also be used to retract the pushrod 216 in the dispensing gun 210 back to the original position. The operation of the pushrod 216 may therefore be completely automated and motorised.

The present invention therefore improves replication in the rate of cement delivery and makes it easy for all users to release the cement from the mixing cylinder 110 at a desired pressure.

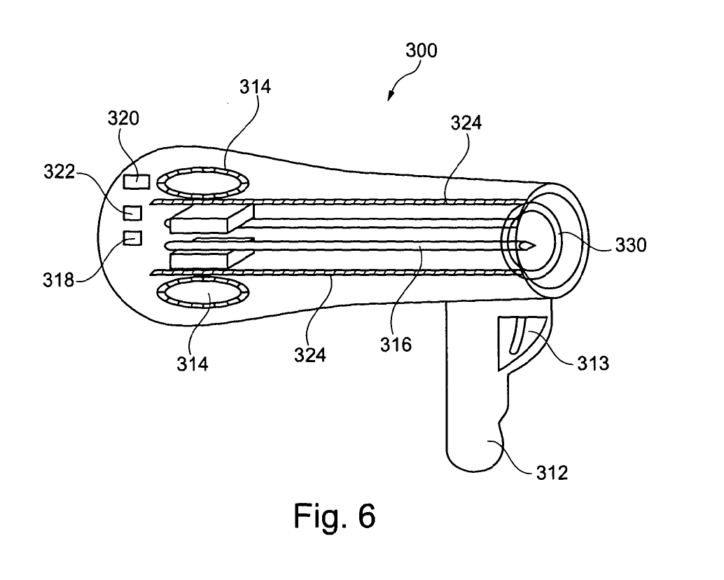

FIG. 6 is a view of a further dispensing gun 300 according to the present invention, The dispensing gun 300 comprises a handle 312 and a trigger 313 for activation. There is also shown drive means 314 on each side of the dispensing gun 300 which is used to activate a pushrod 316 which may be used to dispense the contents of a mixing cylinder 110. There is also shown a mixing button 318, a timer 320 and a reset button 322. There is also shown tracks 324 which again are used to facilitate the working of pulleys 325 to activate the dispensing of the material.

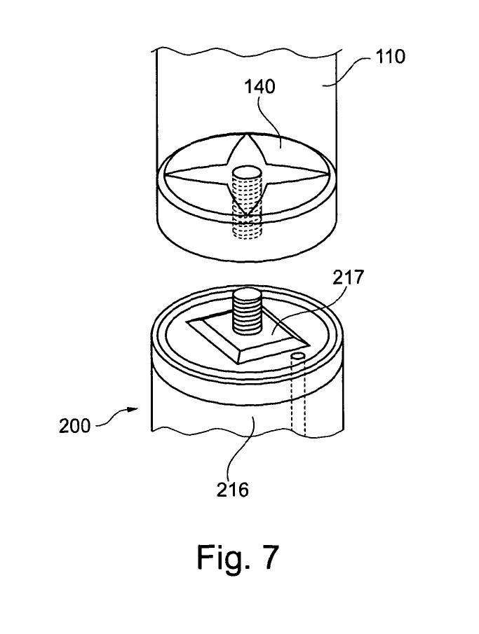

FIG. 7 is a further view of the dispensing arrangement which shows the mixing cylinder 110 and the mixing paddle 140 being in close proximity to part of the dispensing gun 210 and the pushrod 216 which has a member 217 at the end used for pushing the mixing paddle 140.

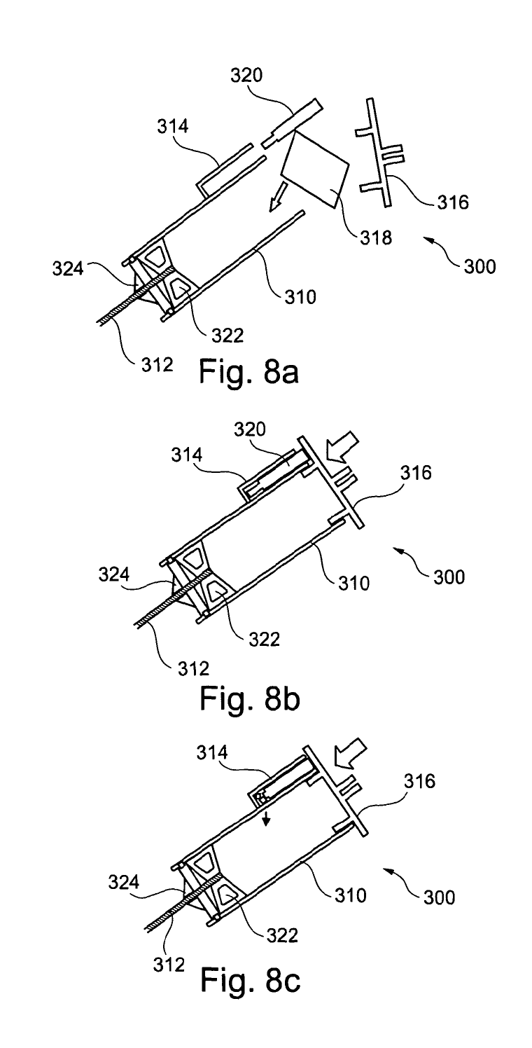

FIGS. 8a-8c are representations of a further bone mixing apparatus 300. The bone mixing apparatus 300 comprises a mixing cylinder 310 and a shaft 312. There is also shown a compartment 314 which is capable of receiving a glass ampoule 320. There is also shown a mixing paddle 322 and a plunger 324. FIG. 8a shows a powder from, for example, a sachet 318 being emptied into the mixing cylinder 310. FIG. 8b shows an end cap 316 being placed into the end of the mixing cylinder 310. In FIG. 8c the end cap 316 is pressed down into and flush against the end of the mixing cylinder 310 which causes the glass ampoule 320 to break and release its contents into the mixing cylinder 310 through an opening 326 in the side of the mixing cylinder 310.

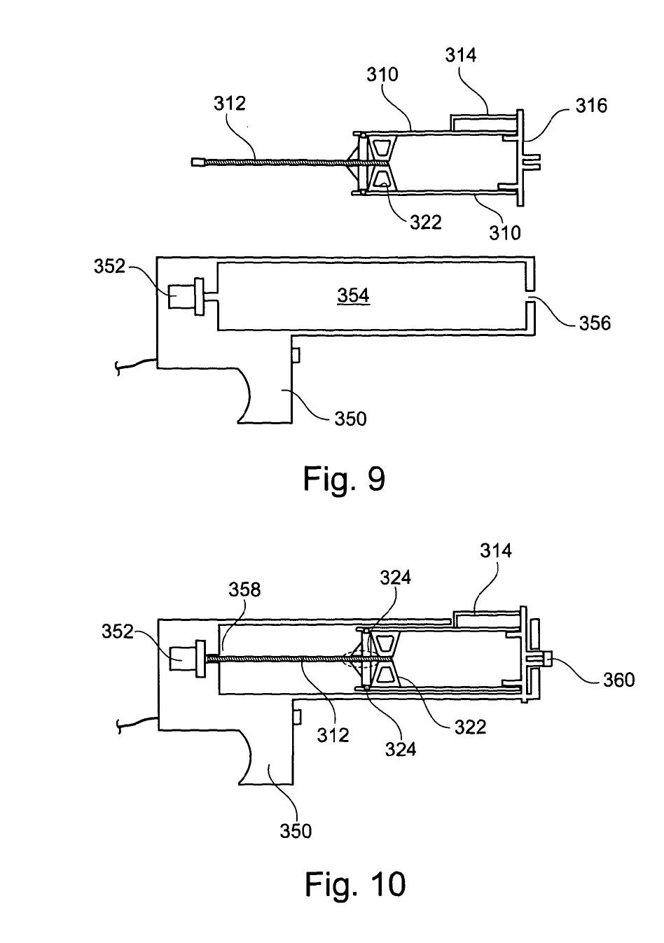

FIGS. 9 and 10 are representations of the bone mixing apparatus 300 shown in FIGS. 8a-8c with a cement dispensing gun 350. The bone mixing apparatus 300 is capable of being placed inside a cavity 354 in the cement dispensing gun 350. The cement dispensing gun 350 also comprises a motor 352 and an outlet 356 at the end of the cavity 354. There is also shown a 2-way thrust bearing 358 attached to the shaft 312.

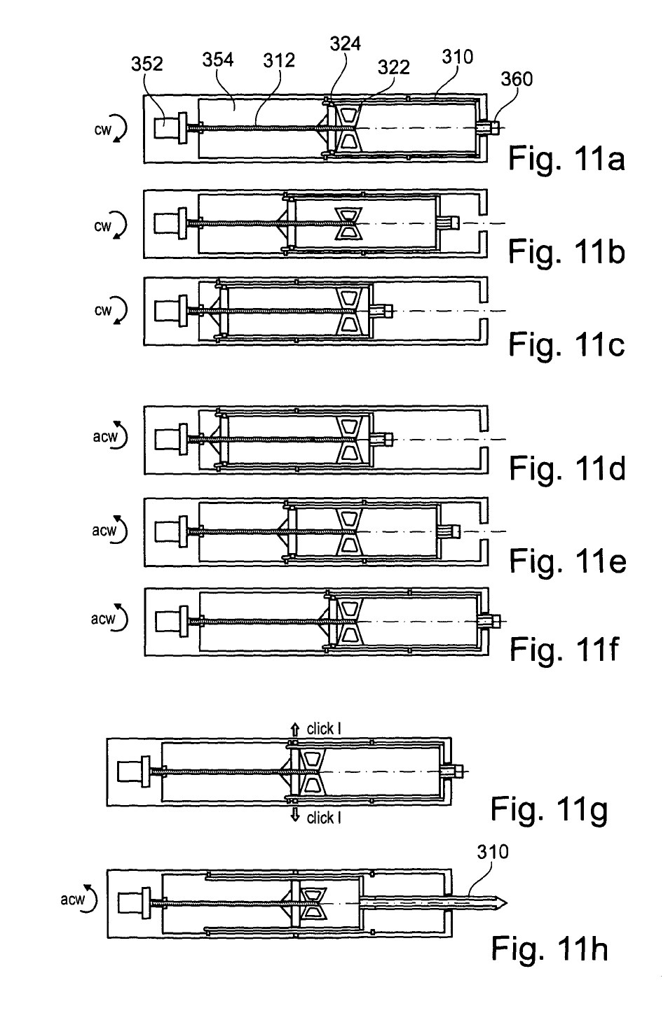

FIGS. 11a-11h show the operation of the bone mixing apparatus 300. In FIGS. 11a-11c the shaft 312 turns clockwise (i.e. ‘cw’). In FIG. 11a the plunger 324 is in a locked position to the mixing cylinder 310. FIG. 11b shows that rotation of the shaft 312 causes the mixing cylinder 310 to translate along the cavity 354 in the cement dispensing gun 350. FIG. 11c shows that efficient mixing occurs along the length of the mixing cylinder 310.

In FIGS. 11d-11f, the shaft 312 turns anti-clockwise (‘acw’) with the mixing cylinder 310 back to its initial position in FIG. 11f.

In FIG. 11g the locks on the mixing cylinder 310 are freed to allow the mixing cylinder 310 to move freely from the plunger 324.

In FIG. 11h the mixing cylinder 310 moves against the plunger 324 allowing the contents of the mixing cylinder to be expelled through a nozzle 370.

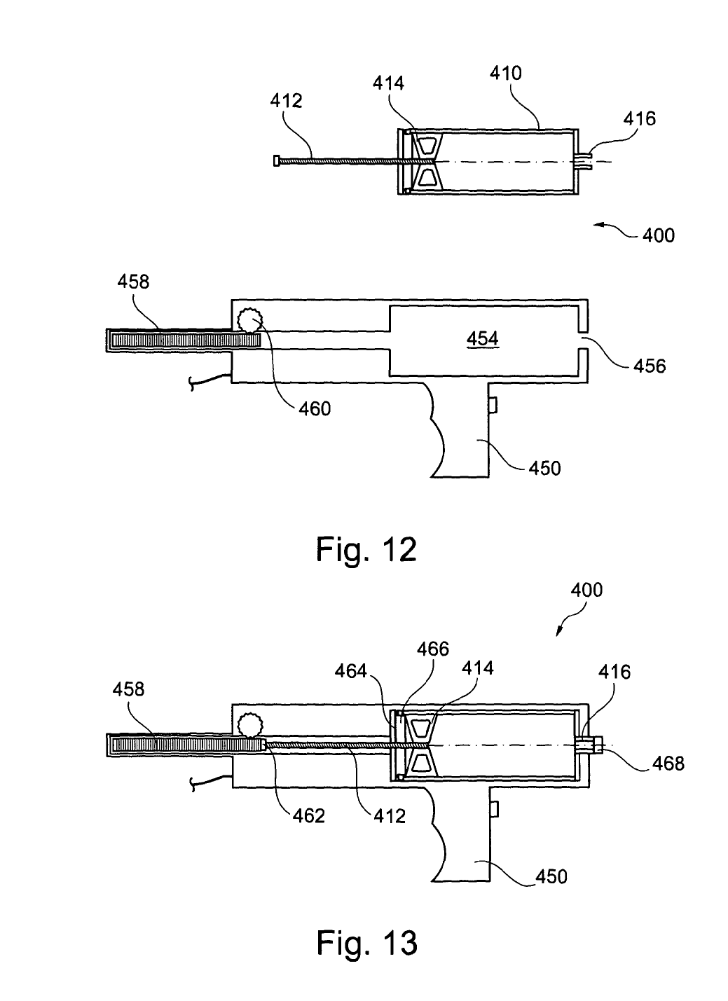

FIGS. 12 and 13 are representations of a further bone mixing apparatus 400. The bone mixing apparatus 400 comprises a mixing cylinder 410, a shaft 412 and a mixing paddle 414. The mixing cylinder 410 also comprises an outlet 416. FIG. 12 also shows a dispensing gun 450 which has a cavity 454 and an outlet 456. The dispensing gun 450 is also shown to comprise a rack 458 and a motor pinion wheel 460. FIG. 13 shows the mixing cylinder 410 attached to the dispensing gun 450. There is also shown a bearing 462 which allows the shaft 412 to rotate and a plunger 466. There is also shown a region 464 which shows a threaded interface.

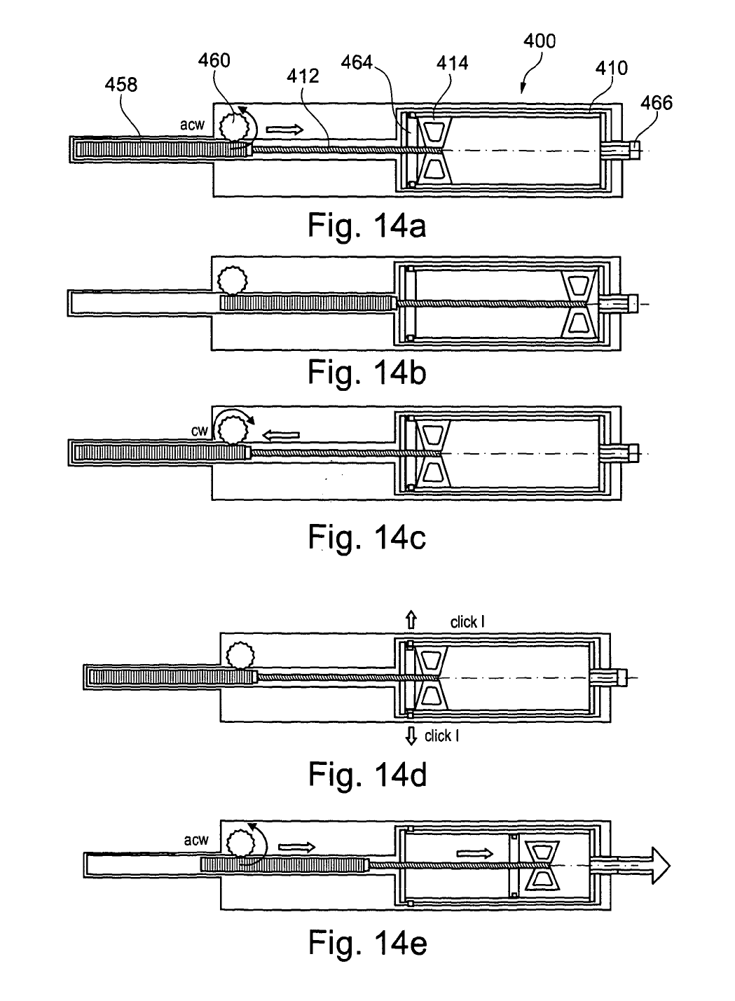

FIGS. 14a-14c show the operation of the bone mixing apparatus 400. FIG. 14a shows the shaft 412 turning anticlockwise (i.e. ‘acw’) the plunger 464 in a locked position into the mixing cylinder 410. FIG. 14b shows the shaft 412 reached its limit. FIG. 14c shows the shaft 412 turning clockwise (i.e. ‘cw’) and the shaft 412 mixing on its return. FIG. 14d is where the motor has stopped and the plunger 464 is unlocked. The nozzle seal 466 can then be removed and FIG. 14e shows the motor engaged to turn the shaft 412 anti-clockwise (i.e. ‘acw’) and the plunger 464 performs.

Whilst specific embodiments of the present invention have been described above, it will be appreciated that departures from the described embodiments may still fall within the scope of the present invention. For example, any suitable type of cartridge may he used to initially store the different material used to contain the components of the bone cement mixing material. Moreover, any suitable type of dispensing gun may be used along with any suitable mixing chamber.

1-28. (canceled)

29. A bone cement mixing apparatus, said bone cement mixing apparatus comprising:
a mixing chamber;
an opening located on the mixing chamber, the opening being closeable and;
wherein the opening on the mixing chamber is capable of receiving the components for forming a bone cement mixture.

30. A bone cement mixing apparatus according to claim 29, wherein the apparatus forms a closed system to mix the different components for forming the bone cement mixture.

31. A bone cement mixing apparatus according to claim 29, wherein the mixing chamber is a mixing cylinder.

32. A bone cement mixing apparatus according to claim 29, wherein the mixing chamber comprises an opening which is in the form of a hatch or a trap door which is capable of receiving the components for forming the bone cement mixture, and wherein there is an opening located on the mixing chamber, the opening being closable using a sprung activated mechanism.

33. A bone cement mixing apparatus according to claim 29, wherein the mixing apparatus comprises a compartment which is capable of being fitted onto the mixing chamber and which is capable of receiving a cartridge, and wherein the cartridge contains the different components which are intended to be mixed to form the bone cement mixture.

34. A bone cement mixing apparatus according to claim 29, wherein once the cartridge is placed on the mixing chamber and over an opening located on the mixing chamber, the compartment may then be removed and the contents of the cartridge dispensed into the mixing chamber, and wherein to facilitate the dispensing of the different components into the mixing chamber, a vacuum or reduced air pressure is formed in the mixing chamber.

35. A bone cement mixing apparatus according to claim 29, wherein a cartridge contains any number of different components which may be contained in separate compartments within the cartridge, wherein the components once dispensed into the mixing chamber are automatically mixed using motorized means.

36. A bone cement mixing apparatus according to claim 29, wherein the bone cement mixing apparatus comprises a nozzle arrangement through which the contents in the mixing chamber are capable of being dispensed.

37. A bone cement mixing apparatus according to claim 29, wherein the mixing apparatus comprises a dispensing gun which provide automated dispensing of the material in the mixing chamber.

38. A bone cement mixing apparatus according to claim 37, wherein the dispensing gun comprises an on/off button, a reset button and/or a timer button.

39. A bone cement mixing apparatus according to claim 37, wherein the dispensing gun comprises a pushrod or lead-screw which is automatically activated thereby progressively pushing the contents out of the mixing chamber and through a nozzle into a bone cavity to be repaired.

40. A bone cement mixing apparatus according to claim 29, wherein to facilitate the mixing of the contents in the mixing chamber, the mixing apparatus comprises mixing means.

41. A bone cement mixing apparatus according to claim 29, wherein the mixing chamber is in the form of a mixing cylinder, the mixing cylinder comprises a centrally located shaft and a compartment capable of receiving a frangible cartridge such as a glass ampoule, the mixing cylinder also comprise a mixing paddle and a plunger, and wherein in use powder used to form the bone cement such as, for example, from a sachet is emptied into the mixing chamber.

42. A bone cement mixing apparatus according to claim 41, wherein an end cap is capable of being placed on the mixing cylinder and as the end cap is placed against the end of the mixing chamber and the end cap pushed down, the frangible cartridge containing liquid material to form the bone cement bursts/breaks and the contents of the frangible cartridge then make contact with the powder material in the mixing chamber.

43. A bone cement mixing apparatus according to claim 41, wherein the contents of the frangible cartridge are capable of entering the mixing chamber through a small side-opening in the mixing chamber.

44. A bone cement mixing apparatus according to claim 41, wherein the mixing chamber is capable of being connected to a dispensing gun and in a first movement, a shaft along with a plunger connected to the dispensing gun is capable of translating along the length of a central cavity in the dispensing gun causing the shaft to rotate and the contents of the mixing chamber to be mixed; and in a second movement, the shaft is capable of moving in the opposite direction along the length of the central cavity causing the shaft to rotate and cause further mixing.

45. A bone cement mixing apparatus according to claim 44, wherein a clip connecting the mixing cylinder to the central cavity of the dispensing gun is then capable of being disconnected and the mixing cylinder is then capable of moving freely from the plunger and the contents of the mixing cylinder are then able to be expelled from the mixing chamber and, for example, expelled through a nozzle.

46. A method for dispensing bone cement mixing material, said method comprising:
providing a mixing chamber;
providing an opening located on the mixing chamber, the opening being closeable; and
wherein the opening on the mixing chamber is capable of receiving the components for forming bone cement mixture.

47. A method for dispensing bone cement mixing material according to claim 46, wherein the method is performed using an apparatus comprising:
a mixing chamber;
an opening located on the mixing chamber, the opening being closeable and;
wherein the opening on the mixing chamber is capable of receiving the components for forming a bone cement mixture.
